(19) United States
(12) Patent Application Publication
(10) Pub. No.: US 2025/0046558 A1
(43) Pub. Date: Feb. 6, 2025

(54) VERTICAL FUSE BLOCK

(71) Applicant: Littelfuse, Inc., Chicago, IL (US)

(72) Inventors: Juan Guerrero, Chicago, IL (US); Sadeddin Lambaz, Chicago, IL (US)

(73) Assignee: Littelfuse, Inc., Chicago, IL (US)

(21) Appl. No.: 18/785,141

(22) Filed: Jul. 26, 2024

Related U.S. Application Data
(60) Provisional application No. 63/529,946, filed on Jul. 31, 2023.

(51) Int. Cl. H01H 85/02; H01H 85/20; H01H 85/38; H01H 85/47

(52) U.S. Cl. CPC H01H 85/0241; H01H 85/205; H01H 2085/0275; H01H 85/38; H01H 85/47

(57) ABSTRACT

Approaches disclosed herein are related to vertically oriented fusible devices and vertically oriented fuse blocks. In one approach, a vertical fuse assembly may include a body comprising an upper section and a lower section, and a fuse extending between an upper terminal and a lower terminal, wherein the upper terminal is positioned within the upper section, wherein the lower terminal is positioned within the lower section, and wherein the lower terminal extends through the lower section. The vertical fuse assembly may further include a side terminal adjacent the fuse body, wherein the side terminal extends through the lower section.

### CROSS-REFERENCE TO RELATED APPLICATION

This application claims priority to pending U.S. Provisional Patent Application No. 63/529,946, filed Jul. 31, 2023, entitled “Vertical Fuse Block,” which is incorporated by reference herein in its entirety.

### FIELD OF THE DISCLOSURE

This disclosure relates generally to the field of circuit protection devices and, more specifically, to a vertically oriented fusible device/block.

### BACKGROUND OF THE DISCLOSURE

Fuses are commonly employed in applications in which it is desirable to implement an overcurrent protection device directly on a printed circuit board (PCB) or other substrate. Some conventional fuses include a fusible element extending along the top on an insulative fuse body between first and second conductive terminals. The terminals are typically bent around opposing ends of the fuse body to an underside of the fuse body where they can be electrically connected (e.g., soldered) to respective contacts on a PCB, for example.

A shortcoming associated with conventional fuses is that they have a relatively large footprint on a PCB or other substrate on which they are installed. Another shortcoming with conventional fuses is that fuseholders typically enclose the fuse and do not allow for heat dissipation, therefore requiring fuse rerating in some instances. It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In one aspect, a vertical fuse assembly may include a body comprising an upper section and a lower section, and a fuse extending between an upper terminal and a lower terminal, wherein the upper terminal is positioned within the upper section, wherein the lower terminal is positioned within the lower section, and wherein the lower terminal extends through the lower section. The vertical fuse assembly may further include a side terminal adjacent the fuse, wherein the side terminal extends through the lower section.

In another aspect, a vertical fuse block may include a body including an upper section and a lower section, and a fuse extending between an upper terminal and a lower terminal, wherein the upper terminal is positioned within the upper section, wherein the lower terminal is positioned within the lower section, and wherein the lower terminal includes a first lead extending through the lower section. The vertical SMD may further include a side terminal adjacent a fuse body of the fuse, wherein the side terminal includes a second lead and a third lead extending through the lower section.

In yet another aspect, a vertically mounted fuse block may include a body including an upper section and a lower section, and a fuse extending between an upper terminal and a lower terminal, the upper terminal is positioned within the upper section, wherein the lower terminal is positioned within the lower section, and wherein the lower terminal extends through the lower section. The vertically mounted fuse block may further include a side terminal adjacent the fuse, wherein the side terminal extends through openings of the lower section.

### BRIEF DESCRIPTION OF THE DRAWINGS

The accompanying drawings illustrate exemplary approaches of the disclosure, including the practical application of the principles thereof, as follows:

FIG. 1A illustrates a perspective view of a vertical fuse assembly, according to embodiments of the present disclosure;

FIG. 1B illustrates another perspective view of the vertical fuse assembly, according to embodiments of the present disclosure;

FIG. 2 illustrates an exploded view of the vertical fuse assembly, according to embodiments of the present disclosure;

FIG. 3A illustrates a perspective view of a lower section of the vertical fuse assembly, according to embodiments of the present disclosure;

FIG. 3B illustrates a perspective view of the lower section of the vertical fuse assembly, according to embodiments of the present disclosure; and

FIG. 4 illustrates a perspective view of a lower terminal of the vertical fuse assembly, according to embodiments of the present disclosure.

The drawings are not necessarily to scale. The drawings are merely representations, not intended to portray specific parameters of the disclosure. The drawings are intended to depict exemplary embodiments of the disclosure, and therefore are not to be considered as limiting in scope. In the drawings, like numbering represents like elements.

Furthermore, certain elements in some of the figures may be omitted, or illustrated not-to-scale, for illustrative clarity. The cross-sectional views may be in the form of “slices”, or “near-sighted” cross-sectional views, omitting certain background lines otherwise visible in a “true” cross-sectional view, for illustrative clarity. Furthermore, for clarity, some reference numbers may be omitted in certain drawings.

### DETAILED DESCRIPTION

Devices, fuses, circuit protectors, assemblies, and methods in accordance with the present disclosure will now be described more fully hereinafter with reference to the accompanying drawings, where various embodiments are shown. The devices, fuses, circuit protectors, assemblies, and methods may be embodied in many different forms and are not to be construed as being limited to the embodiments set forth herein. Instead, these embodiments are provided so the disclosure will be thorough and complete, and will fully convey the scope of the methods to those skilled in the art.

To address the deficiencies of the prior art described above, namely, PCB space and heat dissipation, vertically mounted fuse holders are needed. Embodiments of the present disclosure describe a vertical fuse block consisting of a top assembly and bottom assembly. The top assembly is removable to allow for the insertion of the fuse, similar in concept to a fuseholder knob or cap. The top assembly houses an upper terminal where the fuse can be inserted into and secured by the helical construction of the terminal. The entire top assembly can then be inserted into the bottom assembly.

The bottom assembly consists of a side terminal that the upper terminal is secured to, and a lower terminal. The lower assembly has two guide holes to align the upper terminal, as well as an arc barrier that extends between the lower terminal and the side terminal. In some embodiments, the upper and lower terminals have a helical construction that physically secures the fuse.

As will become further apparent below, at least the following advantages are provided by current disclosure. The vertical mounting of the entire assembly saves on PCB space. The exposed construction allows for the fuse to dissipate heat with no need to rerate the fuse block. Furthermore, the shock-safe construction allows for removing the top assembly without touching live parts. Still furthermore, it is possible to have multiple series that cover existing cylindrical fuses.

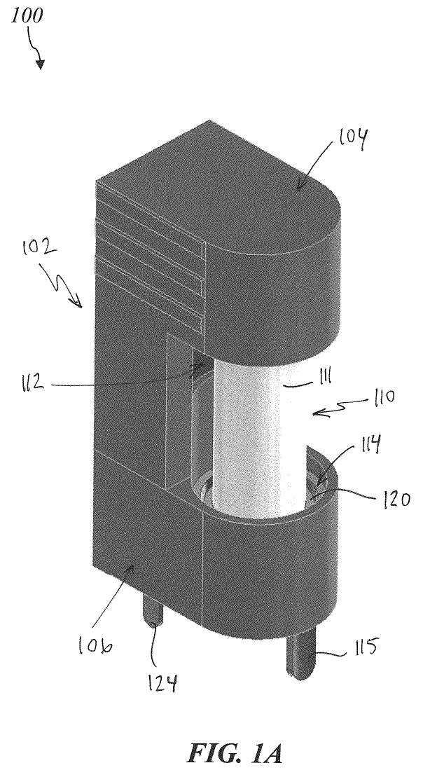

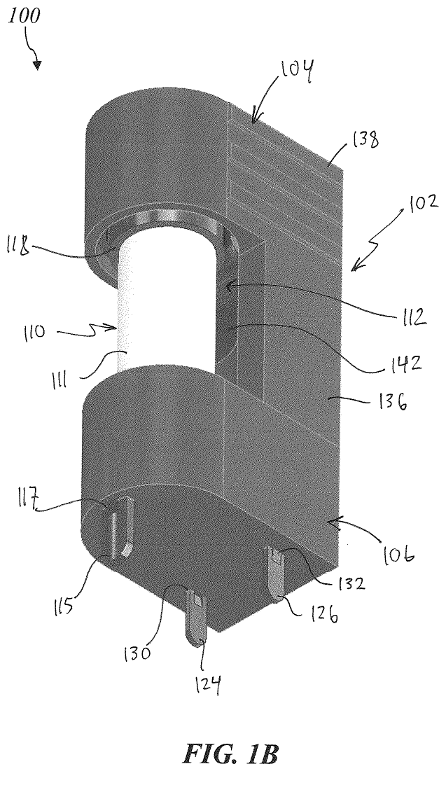

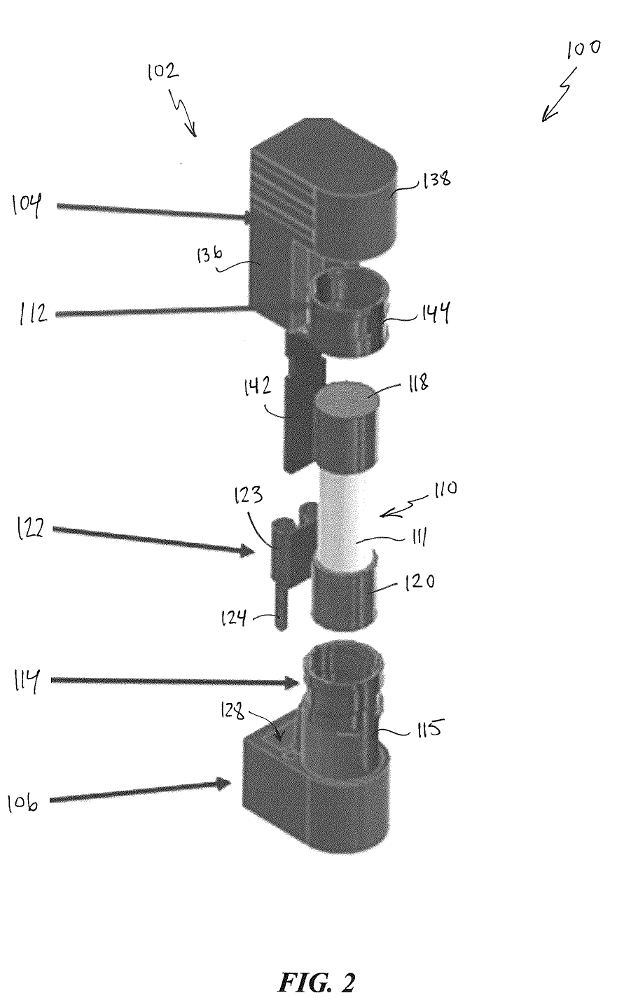

FIGS. 1A-1B illustrate perspective views, and FIG. 2 illustrates an exploded view, of a fuse assembly/block 100 (hereinafter “assembly”) according to embodiments of the present disclosure. As shown, the assembly 100 may include a body 102 having an upper section 104 and a lower section 106, wherein a fuse 110 extends between the upper section 104 and the lower section 106. An upper terminal 112 may be disposed within the upper section 104, and a lower terminal 114 may be disposed within the lower section 106. The lower terminal 114 may include a lead 115, which extends through an opening 117 of the lower section 106.

Although non-limiting, the body 102 may be constructed from an insulative material. More specifically, the upper section 104 and the lower section 106 can be made of the same or different materials, such as an insulating plastic, e.g., nylon, glass-filled nylon, polyester and polycarbonate. Alternative materials may be used in various embodiments.

The fuse 110 may include a fuse body 111 enclosed on opposite ends by a first end cap 118 and a second end cap 120. The first end cap 118 may nest within the upper terminal 112, while the second end cap 120 may nest within the lower terminal 114. The fuse body 111 may be a generally cylindrical-shaped member, which is sized to fit within upper and lower terminals 112, 114. Although not shown, the fuse 110 may include a fusible element within the fuse body 111, extending between upper and lower terminals 112, 114. The fusible element may be configured to melt, disintegrate, or otherwise open if current flowing through the fuse 110 exceeds a predetermined threshold, or “current rating,” of the fuse 110. In certain embodiments, the fusible element may have a serpentine shape and/or may include perforations, slots, thinned or narrowed segments, and/or various other features for making the fusible element more susceptible to melting or opening relative to other portions of the fuse 110. It will be appreciated that the fuse body 111 remains partially exposed to allow for heat dissipation. That is, the first and second end caps 118, 120 may be enclosed by the body 102, while the fuse body 111 is open to an exterior of the body 102.

As further shown, the assembly 100 may include a side terminal 122 adjacent the fuse body 111, wherein the side terminal 122 extends through the lower section 106 of the body 102. In some embodiments, the side terminal 122 may include a body plate 123 and a first lead 124 and a second lead 126 extending from the body plate 123. In some embodiments, the lower section 106 of the body 102 may include a second terminal cavity 128 (FIG. 2) operable to receive the body plate 123 therein, and a set of openings 130 (FIG. 1B) to allow the first and second leads 124, 126 to pass therethrough.

As best shown in FIG. 1B, in some embodiments, the first and second leads 124, 126 may include one or more tabs 132 operable to engage a bottom surface of the lower section 106 to retain the side terminal 122 in place once the first and second leads 124, 126 are inserted through the set of openings 130. The lead 115 may similarly include one or more tabs or retention elements. The first and second leads 124, 126 and the lead 115 of the lower terminal 114 are operable to engage components embedded within, or coupled to, a printed circuit board (not shown).

The PCB provides the circuit routing between the fuses and terminal connections. The PCB includes traces that run from the fuse mounting terminals to the connector terminals, stud connectors, etc. The PCB may be made of FR-4 material but can alternatively be ceramic if a more rigid material is needed. The PCB can be single or multilayered and is customized as desired by the customer. The PCB can provide a wider trace that serves as a buss bar or common connection for the fuse mounting terminals and connector terminals. The buss bar can alternatively or additionally include a connected metal bar, which also acts as a heat sink for the power distribution module.

As best shown in FIG. 2, the upper section 104 may include a first portion 136 connected with a second portion 138. The first portion 136 may include a channel operable to receive a planar portion 142 of the upper terminal 112, while the second portion 138 may include an upper cavity operable to receive an upper cylindrical portion 144 of the upper terminal 112. The first end cap 118 may also extend into the upper cavity of the second portion 138. As shown, the planar portion 142 of the upper terminal 112 is connected to the upper cylindrical portion 144. When the upper section 104 and the lower section 106 are assembled, the planar portion 142 of the upper terminal 112 may be adjacent to, and connected with, the body plate 123 of the side terminal 122.

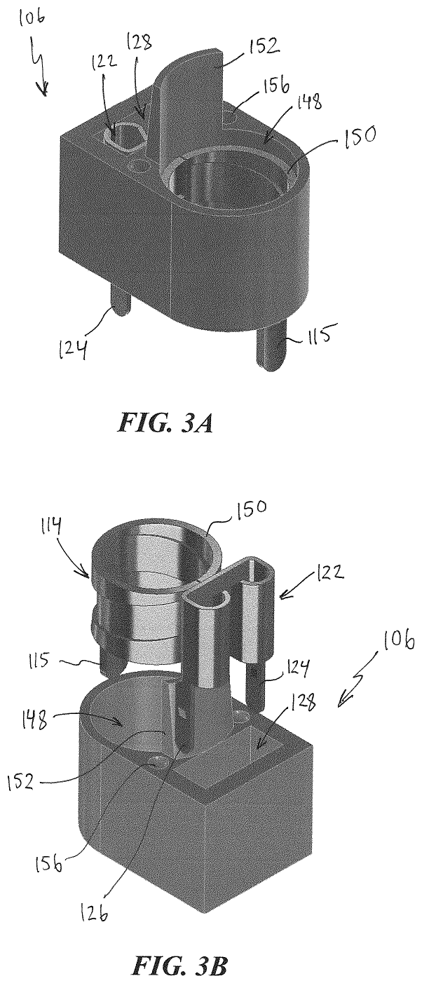

Turning now to FIGS. 3A-3B, the lower section 106 of the assembly 100 will be described in greater detail. As shown, the lower section 106 may include a lower cavity 148 operable to receive a lower cylindrical portion 150 of the lower terminal 114 therein. The lower cavity 148 may be separated from the second terminal cavity 128 by an arc barrier 152. The arc barrier 152 may also separate the lower terminal 114 from the side terminal 122. As shown, the arc barrier may be a wall or element, which extends vertically from an upper surface of the lower section 106, towards the upper section 104. In some embodiments, the lower section 106 may include a set of openings or recesses 156 operable to receive corresponding tabs or posts, which extend from a lower end of the first portion 136 of the upper section 104.

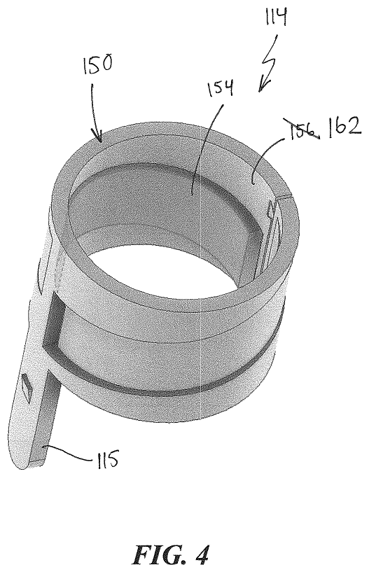

Turning now to FIG. 4, the lower terminal 114 will be described in greater detail. As shown, the lower terminal 114 includes the lower cylindrical portion 150 connected with the lead 115. The lower cylindrical portion 150 may include one or more helical components 154 extending from an inner surface 162 thereof. The helical components 154 may physically secure the lower end cap 120 of the fuse 110 within the lower cylindrical portion 150. It will be appreciated that the upper terminal 112 may also include one or more helical components for similarly securing the upper end cap 118 within the upper section 104 of the body 102. As further shown, the lead 115 may include one or more tabs 160 extending therefrom for engagement with the bottom surface of the lower section 106 of the body 102.

As used herein, an element or step recited in the singular and proceeded with the word “a” or “an” is understood as not excluding plural elements or steps, unless such exclusion is explicitly recited. Furthermore, references to “one embodiment” of the present disclosure are not intended to be interpreted as excluding the existence of additional embodiments also incorporating the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The phrases “at least one”, “one or more”, and “and/or”, as used herein, are open- ended expressions and are both conjunctive and disjunctive in operation. For example, expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

All directional references (e.g., proximal, distal, upper, lower, upward, downward, left, right, lateral, longitudinal, front, back, top, bottom, above, below, vertical, horizontal, radial, axial, clockwise, and counterclockwise) are just used for identification purposes to aid the reader's understanding of the present disclosure. The directional references do not create limitations, particularly as to the position, orientation, or use of the disclosure. Connection references (e.g., attached, coupled, connected, and joined) are to be construed broadly and may include intermediate members between a collection of elements and relative movement between elements unless otherwise indicated. As such, connection references do not necessarily infer two elements are directly connected and in fixed relation to each other.

Furthermore, identification references (e.g., primary, secondary, first, second, third, fourth, etc.) are not intended to connote importance or priority, and are used to distinguish one feature from another. The drawings are for purposes of illustration, and the dimensions, positions, order and relative sizes reflected in the drawings attached hereto may vary.

Furthermore, the terms “substantial” or “approximately,” as well as the terms “approximate” or “approximately,” can be used interchangeably in some embodiments, and can be described using any relative measures acceptable by one of ordinary skill in the art. For example, these terms can serve as a comparison to a reference parameter, to indicate a deviation capable of providing the intended function. Although non-limiting, the deviation from the reference parameter can be, for example, in an amount of less than 1%, less than 3%, less than 5%, less than 10%, less than 15%, less than 20%, and so on.

While certain embodiments of the disclosure have been described herein, the disclosure is not limited thereto, as the disclosure is as broad in scope as the art will allow and the specification may be read likewise. Therefore, the above description is not to be construed as limiting. Instead, the above description is merely as exemplifications of particular embodiments. Those skilled in the art will envision other modifications within the scope and spirit of the claims appended hereto.

What is claimed is:

1. A vertical fuse assembly, comprising:
a body comprising an upper section coupleable with a lower section;
a fuse extending between an upper terminal and a lower terminal, wherein the upper terminal is positioned within the upper section, wherein the lower terminal is positioned within the lower section, and wherein the lower terminal comprises a lead extending through the lower section; and
a side terminal adjacent the fuse, wherein the side terminal extends through the lower section.

2. The vertical fuse assembly of claim 1, wherein the upper section comprises an upper cavity, and wherein the upper terminal extends within the upper cavity.

3. The vertical fuse assembly of claim 1, wherein the upper terminal comprises:
an upper cylindrical portion; and
a planar portion connected to the upper cylindrical portion.

4. The vertical fuse assembly of claim 3, wherein the lower terminal comprises a lower cylindrical portion, wherein the lead is connected to the lower cylindrical portion.

5. The vertical fuse assembly of claim 4, wherein the upper cylindrical portion receives a first end cap of the fuse, and wherein the lower cylindrical portion receives a second end cap of the fuse.

6. The vertical fuse assembly of claim 1, wherein the side terminal comprises a second lead and third lead, and wherein the second lead and the third lead extend through the lower section.

7. The vertical fuse assembly of claim 1, wherein the lower section comprises an arc barrier positioned between the lower terminal and the side terminal.

8. A vertical fuse block, comprising:
a body comprising an upper section and a lower section;
a fuse extending between an upper terminal and a lower terminal, wherein the upper terminal is positioned within the upper section, wherein the lower terminal is positioned within the lower section, and wherein the lower terminal includes a first lead extending through the lower section for connection with a printed circuit board; and
a side terminal adjacent a fuse body of the fuse, wherein the side terminal includes a second lead and a third lead extending through the lower section for connection with the printed circuit board.

9. The vertical fuse block of claim 8, wherein the upper section comprises an upper cavity, and wherein the upper terminal extends within the upper cavity.

10. The vertical fuse block of claim 8, wherein the upper terminal comprises:
an upper cylindrical portion; and
a planar portion extending from the upper cylindrical portion, towards the lower terminal.

11. The vertical fuse block of claim 10, wherein the lower terminal comprises a lower cylindrical portion, wherein the first lead is connected to the lower cylindrical portion.

12. The vertical fuse block of claim 11, wherein the upper cylindrical portion receives a first end cap of the fuse body, and wherein the lower cylindrical portion receives a second end cap of the fuse body.

13. The vertical fuse block of claim 8, wherein the lower section comprises an arc barrier positioned between the lower terminal and the side terminal, wherein the arc barrier is a wall extending vertically towards the upper section.

14. A vertically mounted fuse block, comprising:
a body comprising an upper section and a lower section;
a fuse extending between an upper terminal and a lower terminal, wherein the upper terminal is positioned within the upper section, wherein the lower terminal is positioned within the lower section, and wherein the lower terminal extends through the lower section; and
a side terminal adjacent the fuse, wherein the side terminal extends through openings of the lower section.

15. The vertically mounted fuse block of claim 14, wherein the upper section comprises an upper cavity, and wherein the upper terminal extends within the upper cavity.

16. The vertically mounted fuse block of claim 14, wherein the upper terminal comprises:
an upper cylindrical portion; and
a planar portion extending from the upper cylindrical portion, towards the lower section.

17. The vertically mounted fuse block of claim 16, wherein the lower terminal comprises:
a lower cylindrical portion; and
a first lead connected to the lower cylindrical portion.

18. The vertically mounted fuse block of claim 17, wherein the upper cylindrical portion receives a first end cap of the fuse, and wherein the lower cylindrical portion receives a second end cap of the fuse.

19. The vertically mounted fuse block of claim 14, wherein the side terminal comprises a second lead and third lead.

20. The vertically mounted fuse block of claim 14, wherein the lower section comprises an arc barrier positioned between the lower terminal and the side terminal.
